(19) United States
(12) Patent Application Publication
(10) Pub. No.: US 2024/0262481 A1
(43) Pub. Date: Aug. 8, 2024

(54) MODULAR, REPLACEABLE OUTBOARD FAIRINGS FOR APPLICATION SPECIFIC OPTIMIZATION

(71) Applicant: Flux Marine Ltd., Bristol, RI (US)

(72) Inventor: Benjamin Sorkin, Melville, NY (US)

(21) Appl. No.: 18/634,105

(22) Filed: Apr. 12, 2024

Related U.S. Application Data
(63) Continuation of application No. PCT/US22/46751, filed on Oct. 14, 2022.
(60) Provisional application No. 63/256,404, filed on Oct. 15, 2021.

(51) Int. Cl. B63H 20/32

(52) U.S. Cl. CPC B63H 20/32; B63H 2020/323

(57) ABSTRACT

A marine propulsion apparatus includes a lower unit, the lower unit includes a center body. The center body includes a leading edge disposed at a first end of the center body and a trailing edge disposed at a second end of the center body, defining a substantially cylindrical portion therebetween. The lower unit includes a modular nose cone member releaseably coupled to the leading edge of the center body, the modular nose cone further including a first curved conical surface and a first mating surface. The lower unit includes a modular tail cone member releaseably coupled to the trailing edge of the center body, the modular tail cone further including a second conical surface and a second mating surface, the second mating surface oriented towards and parallel to the first mating surface. The lower unit includes a skeg affixed to a bottom side of the center body.

### CROSS-REFERENCE TO RELATED APPLICATIONS

This application is a Continuation of, and claims the benefit of priority under 35 USC 120 to Patent Cooperation Treaty Patent Application No. PCT/US22/46751 filed Oct. 14, 2022, which claims the benefit of priority under 35 USC 119 to U.S. Provisional Patent Application No. 63/256,404, filed on Oct. 15, 2021, the entirety of which are hereby incorporated by reference.

### FIELD OF THE INVENTION

Embodiments of the present disclosure generally relate to marine propulsion systems. More specifically, the present disclosure relates to modular, replaceable parts enclosing the propeller shaft and extending from the propeller housing (e.g., the skeg, leading edge, and/or trailing edge of a propeller housing).

### BACKGROUND

Historically, the lower unit (torpedo) and skeg section of an outboard motor has a geometry that is determined from manufacture and cannot be changed without significant challenges. Typically, a traditional propulsion system is optimized for one design of propeller operating within specific RPM ranges. Variations between propellers include, but not limited to, diameter, pitch (distance travelled per revolution), rake and hub diameter. Historically, the skeg is manufactured as a single unit with the bullet, therefore, creating challenges if the dimensions require changing. For protection to the propeller, the skeg extends at least as deep as the propeller to inhibit submerged bodies striking the propeller. This limits the size of propeller that can be used as it cannot exceed the depth of the skeg. It is detrimental to use a skeg that is significantly larger than the propeller used as it will increase drag and will increase the draft of the boat (the vertical distance between the water line and deepest point). The leading edge of the torpedo, in some embodiments referred to as a nose cone, pushes through the flow and is designed to minimize drag while allowing water intakes to ingest water for cooling circulation. The optimal profile for a nose cone can change drastically depending on the application. Traditional outboard systems are limited in their ability to change the contour and in many embodiments rely on additional components to be added to adjust the shape. Other variations include the location of water intakes. The tail cone is used to channel the fluid flow from across the body of the torpedo to the hub of the propeller. Traditional outboard systems are optimized for a single hub design, limiting the ability to function efficiently with a range of propellers. Traditionally, outboard motors have been combustion driven and therefore require somewhere to vent exhaust. Often, outboards will use a thru-hub exhaust propeller design that uses a round barrel to which the blades are attached. The exhaust is routed through the gear case and center of the propeller. This has advantages with dampening the exhaust noise and minimizes the induced ventilation on the propeller. However, it requires a larger hub and therefore reduces the frontal blade area of the propeller.

Embodiments of the present disclosure are intended to address the above challenges as well as others.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes A marine propulsion apparatus, the apparatus including a lower unit, the lower unit including a center body, the center body comprising a leading edge disposed at a first end of the center body and a trailing edge disposed at a second end of the center body, defining a substantially cylindrical portion therebetween. The lower unit including a modular nose cone member releaseably coupled to the leading edge of the center body, the modular nose cone further comprising a first curved conical surface and a first mating surface. The lower unit including a modular tail cone member releaseably coupled to the trailing edge of the center body, the modular tail cone further comprising a second conical surface and a second mating surface, the second mating surface oriented towards and parallel to the first mating surface and a skeg affixed to a bottom side of the center body.

To achieve these and other advantages and in accordance with the purpose of the disclosed subject matter, as embodied and broadly described, the disclosed subject matter includes A marine propulsion apparatus including a torpedo. The torpedo including a center body, the center body including a leading edge disposed at a first end of the center body and a trailing edge disposed at a second end of the center body, defining a substantially cylindrical portion therebetween. The torpedo including a modular nose cone member releaseably coupled via at least one fastener to the leading edge, the modular nose cone further including a first curved conical surface and a first mating surface, the first mating surface having a first diameter substantially the same as the leading edge. The torpedo including a modular tail cone member releaseably coupled via at least one fastener to the trailing edge, the modular tail cone further including a second conical surface and a second mating surface, the second mating surface oriented towards and parallel to the first mating surface and wherein the second mating surface includes a second diameter substantially the same as the trailing edge. The torpedo including a propeller shaft disposed axially within the center body, terminating at the modular nose cone at a first end, and extending through the trailing edge at a second end. The torpedo including a propeller rotatably fixed to the propeller shaft aft of the modular tail cone, the propeller including a plurality of blades. The torpedo including a propeller cone rotatably fixed to the propeller shaft aft of the propeller and a skeg affixed to a bottom side of the cylindrical portion of the center body.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE SEVERAL VIEWS OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 illustrates an isometric view of an outboard motor according to embodiments of the present disclosure.

FIG. 2 a block diagram representing component level interactions between the propulsion system as a whole and the dual strut lower unit according to embodiments of the present disclosure.

FIG. 3 illustrates a partial side view of the dual strut and lower unit bullet architecture taken generally below the line 1-1 of FIG. 1 according to embodiments of the present disclosure.

FIG. 4 illustrates a partial front view taken generally below the line 1-1 of FIG. 1 according to embodiments of the present disclosure.

FIG. 5 illustrates a cross-sectional side view taken generally below the line 3-1 of FIG. 3 according to embodiments of the present disclosure.

FIG. 6 illustrates a cross-sectional top view taken generally below the line 3-1 of FIG. 3 according to embodiments of the present disclosure.

FIG. 7 illustrates a cross-sectional front view taken generally below the line 3-1 of FIG. 3 according to embodiments of the present disclosure.

FIG. 8 illustrates a schematic representation of an outboard power transmission system according to embodiments of the present disclosure.

FIG. 9 illustrates a schematic representation of a belt-drive transmission system according to embodiments of the present disclosure.

FIGS. 10A-10B illustrate a computational fluid dynamics visualization of a dual strut and a single strut according to embodiments of the present disclosure.

FIG. 11 illustrates a graphical representation of initial computational fluid dynamics drag results of a dual strut (left) compared to a single strut (right) according to embodiments of the present disclosure.

FIG. 12A-D illustrates a series of side profile views of an exemplary modular nose cone, tail cone, and skeg connected to a center body in accordance with an embodiment of the present disclosure.

FIG. 13 illustrates a side profile view of an exemplary modular nose cone, tail cone, and skeg connected to a center body in accordance with an embodiment of the present disclosure.

FIGS. 14A-14B illustrate two exemplary nose cones optimized for different uses in accordance with an embodiment of the present disclosure.

FIG. 15 illustrates a cross-sectional view of a nose cone with internal reservoir for heat dissipation in accordance with an embodiment of the present disclosure.

FIG. 16 illustrates a modular tail cone with integrated pre-swirl vanes in accordance with an embodiment of the present disclosure.

FIG. 17 illustrates an exemplary nose cone with external access mounting hardware for rapid replacement in accordance with an embodiment of the present disclosure.

FIG. 18 illustrates a nose cone with an integrated fluid sensor to measure water quality used in oceanographic research in accordance with an embodiment of the present disclosure.

FIG. 19 illustrates a side by side view of velocity profiles for two cross-sectional shapes of two modular nose cones.

FIG. 20A-B illustrates a cooling system disposed within struts and entering the modular nose cone configured to flow fluid through said system.

### DETAILED DESCRIPTION

The present disclosure details the components and their benefits that comprise a system of modular fairings for an outboard motor. The fairings of an outboard motor include any component affixed to the main structure of the outboard. This includes, but is not limited to, a nose cone at the leading edge of the lower unit. A skeg that protrudes below the lower unit, a tail cone that affixes to the rear of the lower unit, a prop cone that affixes aft of the propeller, onto the propeller shaft. This system of modular components is designed such that equivalent components can be interchanged with the goal of optimizing the propulsion system for different use case applications. Parameters that can be changed between components include, the length of the skeg, the outer contour of the nose cone and tail cone and the diameter and shape of the prop cone. In some embodiments, additional cooling elements can be added to the system to increase the thermal dissipation capabilities of the system.

The drag on the submerged portion of an outboard motor opposes the thrust generated by the propeller. The relationship between the speed of the object and the drag created is not a linear relationship and is highly dependent on the frontal area size, shape and orientation to the flow of water. The leading edge and trailing edge work in conjunction with each other to transmit a high energy flow across the propeller while minimizing the drag. Using a modular design, the nose cone and tail cone can be changed together or separately to modify the flow that is reaching the propeller. Variations include but are not limited to, changes in the focal point and radius of the curve to optimize the drag effect for a certain flow velocity. The tail cone works in conjunction with the nose cone to bend the flow to meet the propeller blades in a continuous high energy flow path. A modular tail cone allows the torpedo to optimize the flow for different hub diameters. The present disclosure enables one propulsion system to operate at higher efficiency across multiple different operational profiles.

The powertrain of an outboard motor generally includes a prime mover, such as a combustion engine or electric motor, a vertical drive shaft, bevel gear, clutch, and propeller shaft (to which a propeller is attached). Bevel gears are gears between two intersecting shafts where the tooth-bearing faces of the gears are conical in shape. Bevel gears offer higher efficiency than other gear options and may allow for a gear reduction between the intersecting shafts. A clutch is used to allow the prime mover to operate in a single direction but also may allow the propeller shaft to rotate in both clockwise and counterclockwise directions. In various embodiments, outboards may use a dog clutch to switch between forward, neutral and reverse. This requires engaging and disengaging the shifting gears, leading to expedited wear on the teeth of the gear. To minimize this wear, the entire assembly may be submerged in an oil or lubricant that can be harmful to the environment and difficult to dispose of. Heat dissipation from key components including but not limited to, the prime mover, gears and bearings may be integral for reliable operation of this type of outboard motor. Outboard motors may ingest fluid (e.g., sea water) from the body of fluid (e.g., the sea) in which it operates to circulate the fluid around the system and cool components. However, this external fluid intake can bring in contaminants, including but not limited to salt, sand, and/or dirt that can expedite the wear and corrosion process. In some embodiments, the prime mover may be housed within the lower unit, below the water line. This configuration brings advantages with simplicity but may limit heat transfer capability. In various embodiments, other means of power transmission in place of a vertical drive shaft and bevel gears include, for example, chain-driven and belt-driven systems. In various embodiments, synchronous belts may be strong and durable, enabling potential use in higher power marine engine transmissions. In various embodiments, implementation of such belt or chain technologies may present challenges in physical housing arrangements and mechanical assembly as frontal area and hydrodynamic shape of submerged portions of marine propulsion systems greatly affects system drag and efficiency.

Accordingly, marine propulsion systems are needed that are optimized for belt-driven and chain-driven motors while reducing drag (e.g., improving hydrodynamic qualities) and improving heat dissipation. Embodiments of the present disclosure are intended to address the above challenges as well as others.

In various embodiments, a sterndrive or outboard marine propulsion system includes a prime mover that transmits power to a driven shaft through a synchronous belt, an anti-ventilation plate, a lower unit housing, one or more skegs extending from the bottom of the lower unit housing, and a set of struts (e.g., two struts) that connects the lower unit housing to the anti-ventilation plate and attachment point on the cowling (and/or frame structure within the cowling). In various embodiments, the set of struts may be substantially aligned (e.g., parallel) with one another. In various embodiments, each strut may include one or more (e.g., a plurality) of removably attachable and modular trailing edge pieces. In various embodiments, removably attachable trailing edge pieces may allow for fine tuning of hydrodynamic properties.

In various embodiments, the attachment point connects the midsection to the lower unit and prime mover in the embodiment of an outboard marine propulsion system or connects the lower unit and outdrive in the case of a sterndrive marine propulsion system. In various embodiments, particular variables of the system enable lower drag, higher performance, and efficient accommodation of belt drive technologies. In various embodiments, components of the marine propulsion system may be modular, replaceable, and/or built such they have integrated cooling channels. In various embodiments, integration of heat dissipation functionality into a multi-strut (e.g., dual-strut) architecture may provide increased surface area from the multiple struts to optimize heat transfer capability. In various embodiments, multiple struts (e.g., two struts) increases the surface area of the struts in contact with water, thereby improving heat transfer (e.g., conduction) with the water (similar to the heat transfer of fins).

In various embodiments, frontal area and hydrodynamic shape of submerged portions of marine propulsion systems may affects system drag and efficiency. Reducing the drag on a marine propulsion system has direct improvement on the net efficiency of the system. In various embodiments, as the set of struts may be submerged when in use, the set of struts may have any suitable hydrodynamic shape to thereby reduce and/or optimize drag. For example, each strut may include an airfoil shape where the leading edge of the airfoil corresponds to the leading side of the strut.

When in operation, a belt generally has a tight side and a slack side. In various embodiments, the belt may be isolated (i.e., sealed) from the surrounding body of water in which the motor operates. In various embodiments, both sides of the belt may be supported to provide tension to the belt. In various embodiments, providing tension to the belt may reduce (e.g., stop) contamination from the surrounding water. In various embodiments, the marine propulsion system may include, among other things, a continuous loop power transmission device. For example, the prime mover may be mechanically (e.g., rotationally) coupled to the propeller via a belt or chain.

In various embodiments, each strut may be positioned at a predetermined distance from one another to thereby allow fluid flow between the struts. For example, in a dual-strut arrangement, the struts may be positioned about 2 to about 24 inches from one another. In various embodiments, the struts may be positioned about 1.5 to 6 inches from one another. In various embodiments, in larger applications (e.g., yachts, tugboats, etc.), the struts may be positioned several feet apart. In various embodiments, the struts may be positioned up to about 12 feet apart. In various embodiments, the spacing of the struts may be dependent on one or more performance factors, such as, e.g., (1) hydrodynamic interactions between the struts and/or (2) hydrodynamic drag of the lower unit. In various embodiments, as struts become wider, fewer fluid interactions may occur between the multiple struts (interference). In various embodiments, wider struts may improve certain performance factors. In various embodiments, the size (e.g., drag area) of the lower unit may be minimized to thereby minimize drag. In various embodiments, the size of the lower unit may be minimized by providing a small frontal area of the lower unit. In various embodiments, the size of the lower unit may be proportional to the size of the struts. For example, for wider struts, a larger lower unit may be provided. In various embodiments, the struts may not be parallel. For example, the struts may be non-linear or disposed at an angle (e.g., a ‘V’ shape) with respect to the horizontal (sea level).

In various embodiments, each strut may include a cross-sectional profile of the vertical struts that minimizes the drag through water. In various embodiments, the cross-sectional profile may reduce (e.g., minimize) the drag area while allowing for enough void space to house the continuous loop (e.g., belt or chain). In various embodiments, each strut may include an airfoil shape. In various embodiments, any struts (e.g., some or all struts) may have a substantially uniform shape along its length. In various embodiments, any struts (e.g., some or all struts) may have a varying shape along its respective length. For example, a strut may taper, from the leading to trailing edges, from a wider airfoil (having a higher drag area) to a thinner airfoil (having a lower drag area) or vice versa. In various embodiments, any struts (e.g., some or all struts) may have a substantially uniform width (in the direction of flow) along the length of the strut. For example, an airfoil shape may have a substantially similar (e.g., equal) chord length and/or camber line along the entire length of the strut. In various embodiments, any struts (e.g., some or all struts) may have a varying width (in the direction of flow) along the length of the strut. For example, an airfoil shape may have a varying chord length and/or camber line along the entire length of the strut. The struts can have mirroring shapes that are symmetrical about a central axis passing through the struts: alternatively, each strut can be formed with a unique shape/profile relative to the adjacent strut.

In various embodiments, each strut may include separate void spaces configured to house each side of the continuous loop (i.e., the slack side and the taut side). In various embodiments, the separate void spaces within either one or all of the vertical struts may be configured to transfer fluid (e.g., a heat transfer fluid) throughout the outboard.

In various embodiments, one or more of the struts may include a parting line to thereby separate the strut into two or more pieces. In various embodiments, parting lines allow for ease of access so that a continuous loop (e.g., chain or belt) may be installed or removed during or after manufacture (e.g., for repairs). The parting line(s) can be extend along the entire portion of the strut (e.g. between nose cone and anti-ventilation plate).

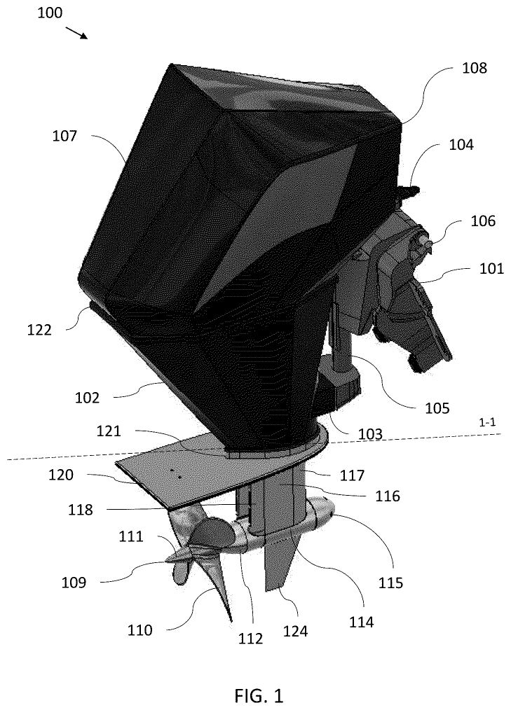

FIG. 1 illustrates an isometric view of an outboard marine propulsion system 100. In various embodiments, the marine propulsion system 100 (e.g., an outboard motor) may include a powerhead section, prime mover cowling, belt drive, anti-ventilation plate, dual strut transmission housing, lower unit with propeller, and skeg. In various embodiments, the outboard marine propulsion system 100 includes a mount 101 configured to releasably couple the transom of a boat to the outboard midsection 102 via a transom mount pad 103. In various embodiments, the outboard motor may be steered through a variety of methods, including but not limited to cables, pulleys, hydraulic and/or electromechanical actuators that mount to the steering bracket 104 and rotate the outboard motor around an axis of the steering tube 105. In various embodiments, the angle of the outboard motor, and thus the angle of propulsion, can also be controlled around the tilt axis 106. In various embodiments, the prime mover components, whether electrically or liquid fuel powered, are located underneath the top cowling 107. In various embodiments, a side of the cowling 107 facing the transom of the boat may include a face plate 108. In various embodiments, the drive shaft of the prime mover is connected via a synchronous drive belt (not shown) to the propeller shaft 109. In various embodiments, the synchronous drive belt, in turn, drives the propeller 110, creating momentum to propel the boat on which the marine propulsion system 100 is affixed. In other embodiments, the propeller may be replaced by an impeller, waterjet, or other propulsive device. In this embodiment, a propeller tail cone 111 and tail fairing 112 match the geometric profile of the propeller to minimize turbulent losses and maximize efficiency. In other embodiments, the propeller tail cone 111 and tail fairing 112 shapes can be adjusted to match different propellers. A sprocket (disposed inside the lower unit) is concentrically mounted to the propeller shaft 109 and housed inside the lower unit 114. In various embodiments, the lower unit 114 may include a nose cone 115 on a leading portion thereof. The one or more struts 116 provide an open pathway for the belt to transmit power from a sprocket attached to the prime mover under the top cowling 107 to the sprocket on the propeller shaft 109. The separate struts 116 bodies allow for the belt to operate without additional rolling components, enabling the highest possible efficiency. The one or more struts 116 are spaced in such a way that the belt does not need to be guided around obstacles or shapes as it has been required to do so in prior art. The strut bodies have hydrodynamic strut leading edges 117 and strut trailing edges 118 that reduce drag and maximize laminar flow to the propeller 110. The struts 116 connect to the anti-ventilation plate 120, which is fastened to the midsection bottom collar 121. This, in turn, fastens to the bottom of the midsection. In various embodiments, a midsection top collar 122 may provide an interface between the midsection 102 and the top cowling 107. In various embodiments, one or more skeg 124 is disposed below the lower unit. In various embodiments, where two or more skegs are provided, each skeg may be positioned equiangularly around the lower unit 114, and located upstream of the propeller.

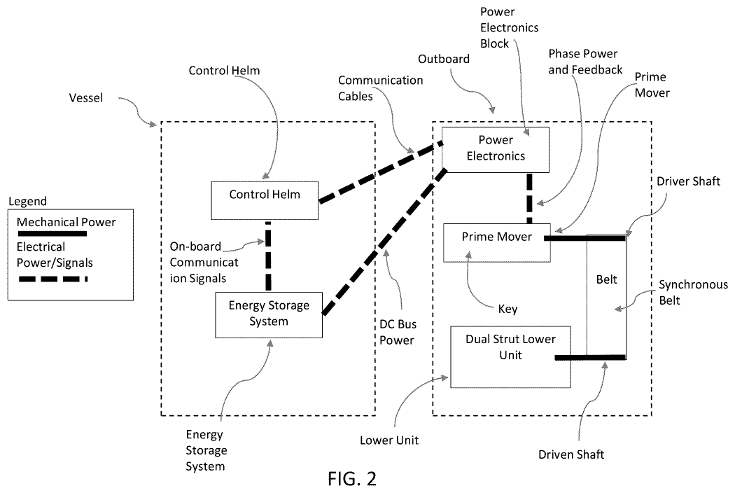

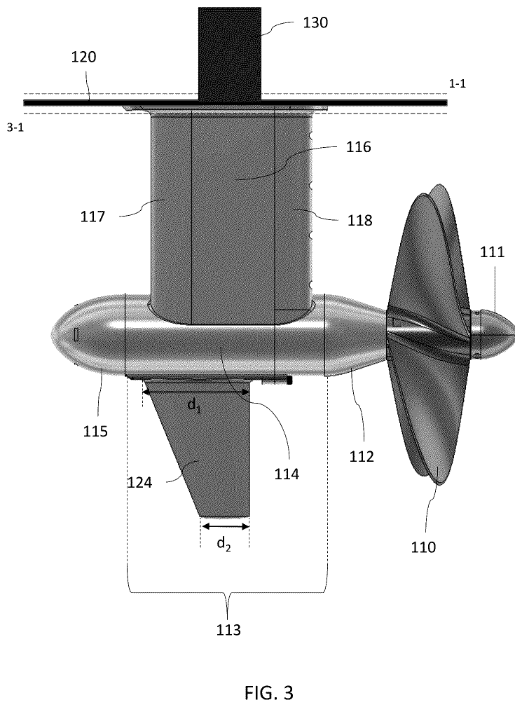

FIG. 2 illustrates a block diagram 200 representing component level interactions between the propulsion system as a whole and the dual strut lower unit. Component blocks are generally located in either the vessel or in the outboard, and are connected either mechanically or electrically as indicated by the legend. In various embodiments, the operator controls the system via the control helm, which uses on-board communication signals to interface with the energy storage system and additional communication cables to interface with the power electronics in the outboard. Communication protocols including, but not limited to, serial, CANbus, SPI, analog, and digital could be used. In various embodiments, the Energy Storage System is connected to the power electronics block through a DC Bus. In various embodiments, the DC bus may range from 12V to over 900V. In various embodiments, the power electronics block generally encompasses all power stage and control components required to use DC voltage to drive a prime mover. In various embodiments, based on signals from the control helm, the power electronics may pull energy from the Energy Storage System through the DC Bus and control the prime mover. In various embodiments, the prime mover may be an electric motor, through Phase Power and Feedback signals. In various embodiments, the prime mover is mechanically coupled through a driver shaft to the synchronous belt. In various embodiments, the belt rotates a driven shaft located inside the lower unit to thereby power a propeller.

FIG. 3 illustrates a partial side view of the dual strut and lower unit bullet architecture taken generally below the line 1-1 of FIG. 1. Line 1-1, in some embodiments, is the water line of the outboard during operation. When in operation, all components below the waterline 1-1 are submerged and contribute to the hydrodynamic drag of the system. As described in the background, sterndrives and outboard marine propulsion systems may use single strut housings that connect gearcases to powerheads. Additionally, nearly all combustion outboards use a shaft and bevel gear system to transmit power from the combustion or electric powerhead to the propeller. In that type of lower unit, a mechanical mechanism is required for switching from forward to neutral to reverse. This type of power transmission requires consistent maintenance for lubricating the gears, wears quickly because of shifting at non-zero rotational speed, and may result in a 15% efficiency loss. The bevel gears also generate significant noise.

Recent advancements in material technologies have enabled the development of more robust synchronous belt drives which have the potential to increase efficiency, decrease noise, reduce maintenance, and lower cost. The present disclosure enables the use of a synchronous belt in a marine propulsion system, through a multi-strut body arrangement where each side of the belt travels through a different strut. Additionally, the present disclosure also provides a method for using electronic reversing from an electric prime mover, thereby eliminating the need for a complex mechanical shifting solution.

In various embodiments, the multi-strut design minimizes fluid flow obstruction to the propeller while moving. In various embodiments, the multi-strut (e.g., dual-strut) design reduces drag-inducing frontal area (i.e., the drag area) while increasing robustness of the entire system. In various embodiments, the strut 116 and anti-ventilation plate 120 interface is integrally formed. In various embodiments, the strut 116 and anti-ventilation plate 120 interface is mechanically fastened (e.g., with bolts and nuts). In various embodiments, the bottom of the struts may be integrally formed with the lower unit 114. In various embodiments, the lower unit 114 may be bullet-shaped (a bullet+bullet casing). In various embodiments, a first portion (e.g., the taut side) and a second portion (e.g., the slack side) of a synchronous belt 130 is protected from water and/or external fluids inside a void space within first and second struts 116. Thus the belt 130 extends (vertically when in operation) through the first strut 116, into the lower unit 114, where it engages and drives the propeller 110 forward/reverse), and up through the second strut 116, and back into the cowling 107.

In various embodiments, drag may be reduced through hydrodynamic shapes applied to the leading edges 117 and trailing edges 118 of the struts 116. In various embodiments, convex surfaces on the sides of the struts 116 between the leading edges 117 and the trailing edges 118 reduce form drag and wave creation. In various embodiments, the profile of the convex surfaces does not have to be symmetric between struts and could be changed for different applications (i.e., not all struts have to be identical in shape). In various embodiments, struts 116 may be reflections of one another (e.g., a first strut may be a reflection of a second strut). In various embodiments, the sides of the struts 116 may be substantially parallel and of equivalent lengths. In various embodiments, the struts could be non-parallel. In various embodiments, the space between the struts may increase or decrease over the height of the struts.

In various embodiments, the sides of the struts 116 may have no concavity. In various embodiments, the leading edges 117 can be integrally formed with the strut 116. In various embodiments, the leading edges 117 may be separately manufactured and removably fastened to the strut 116. In various embodiments, the trailing edges 118 may be integrally formed with the strut 116. In various embodiments, the trailing edges 118 may be separately manufactured and removably fastened (e.g., with a screw, bolt, etc.) to the strut 116 via, for example, a strut attachment point. In various embodiments, the leading edges 117 and/or the trailing edges 118 may be modular and swappable for performance optimization. Additionally or alternatively, the strut(s) can include an access panel to allow repair and inspection of the belt. The access panel can be spaced from the leading/trailing edge and located within the generally planar section of the strut(s).

In various embodiments, the strut(s) may include active control of surface shapes of the leading and/or trailing edges during operation. For example, an electronic control (e.g., real time or manual) may change a camber or chord length of an airfoil shape. In another example, an electronic control (e.g., real time or manual) may change a width (e.g., drag area) of an airfoil shape such that the continuous loop (e.g., belt) has enough room to operate in the void space.

Further aiding in hydrodynamic drag reduction and increasing propulsive efficiency is the overall shape of the architecture. In various embodiments, incoming fluid flow interacts with the nose cone 115 first. In various embodiments, the nose cone 115 geometry may be designed with a smooth transition from the nose cone 115 over the nose cone/lower unit interface and to the lower unit 114. In various embodiments, the nose cone 115 is removable and swappable. In various embodiments, the nose cone 115 may include any suitable shape. For example, the nose cone 115 may include a blunt bullet-like shape. In various embodiments, a center body 113 of the lower unit 114 may have a substantially cylindrical shape (e.g., a bullet casing shape). In another example, the nose cone 115 may be substantially conical with a sharper point. In various embodiments, as fluid flow passes the lower unit 114, the tail fairing 112 may minimize loss-inducing boundary layer separation over the tail fairing/lower unit interface as boundary layer separation may cause turbulent flow thus increasing pressure drag on the propulsion system 100. In various embodiments, the tail fairing 112 is shaped such that the tail fairing/propeller hub interface hydrodynamically meshes with the propeller hub to optimize flow entering the propeller. Thus, the struts 116, lower unit 114, nose cone 115 and tail faring 112 can be configured with a virtually seamless design in which there are no abrupt changes in size/shape/diameter, with the assembly of these components forming a continuous outer surface area to minimize drag.

In various embodiments, the tail fairing may be a frustoconical shape tapering from a larger diameter at the center body 113 to a smaller diameter at the propeller 110. In various embodiments, as the propeller 110 spins and generates regions of high and low pressure, flow is directed over a propeller tail cone 111 to reduce turbulent flow and thus further minimize drag on the propulsion system 100. In typical combustion-type marine engines, engine exhaust is generally directed down through a singular piece and out through the center of the propeller. The present disclosure eliminates this style of exhaust and allows for a more efficient overall hydrodynamic approach.

In various embodiments, one or more skeg 124 may be attached to the center body 113 of the lower unit 114. In various embodiments, the center body 113 may include one or more skeg attachment points configured to allow attachment of one or more skegs 124. In various embodiments, the skeg 124 may have a generally fin-like shape. In various embodiments, the skeg 124 may have a constant thickness along its length. In various embodiments, the skeg 124 may have a varying depth along its length. For example, the skeg 124 may taper from a first, larger depth, d₁, to a second, smaller depth, d₂. In various embodiments, one side of the skeg 124 may be vertical while the other side tapers. In various embodiments, both sides of the skeg 124 may taper. In various embodiments, the skeg 124 may have a curvilinear or airfoil shape, similar to the struts 116. In various embodiments, the skeg 124 is removable and replaceable at the skeg/lower unit interface. In various embodiments, the skeg 124 can be integrally formed at the skeg/lower unit interface. In various embodiments, the skeg 124 contributes to stability and hydrodynamic flow interaction by having a trailing edge that minimizes flow disturbances going into the propeller 110. In various embodiments, the bottom-most edge of the skeg 124 may be lower than the blades of the propeller 110, providing protection to the propeller 110 from physical object strikes. Additionally or alternatively, the location of the skeg 124 can be adjusted up/down stream relative to the lower unit 114.

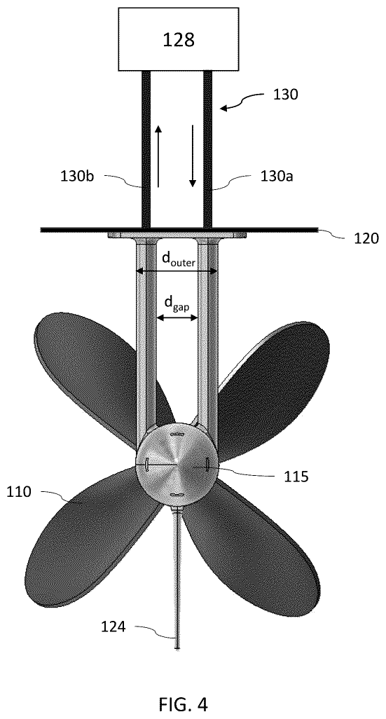

FIG. 4 illustrates a partial frontal view taken generally below the line 1-1 of FIG. 1. As shown in FIG. 4, the prime mover 128 is rotationally coupled to the belt 130 via a drive shaft (not shown). As the prime mover rotates, either the left side 130a of the belt 130 or the ride side 130b of the belt 130 may transmit rotational force to and from the propeller. In the example shown, where the belt 130 is rotating counter-clockwise (from the viewpoint of the prime mover 128), the left side 130a of the belt is the slack side and the right side 130b of the belt 130 is the taut (i.e., in tension) side. In various embodiments, the width of the gap between the two struts 116 (as measured by the distance between the inside edges of each strut) allows for passage of fluid (e.g., sea water) and can be changed to accommodate larger or smaller overall component dimensions, while keeping the ride side 130b of the belt 130 and left side 130a of the belt 130 parallel with one another. In various embodiments, the distance, d_{gap}, between the inside edges of the struts 116 can be varied based on ideal performance metrics, e.g., to reduce frontal (drag) area. In various embodiments, the distance, dₒᵤₜₑᵣ, between the outside edges can also be varied, for example, to accommodate thicker pitched belts. In various embodiments, the strut/lower unit interface may have a gradual, hydrodynamic shape to minimize flow disturbances as water travels through the struts 116 to the propeller 110. In various embodiments, the propeller 110 may be placed in front of the struts 116. In various embodiments, the anti-ventilation plate 120 may connect to the top (i.e., a proximal end) of the struts 116 and may prevent the propeller from sucking air from the surface. The anti-ventilation plate may be referred to colloquially as a “cavitation Plate”. The upper end of struts 116 can connect directly to the cowling 107: additionally or alternatively, the upper end of struts 116 can connect to a mounting plate/frame which receives the cowling 107.

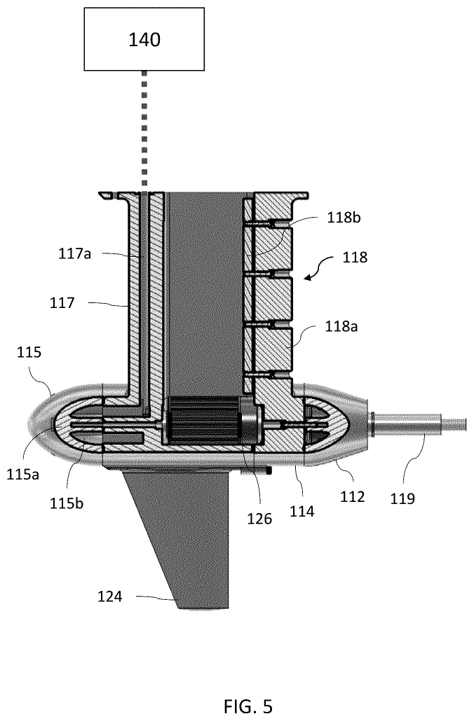

FIG. 5 illustrates a partial side view, partially in section, taken generally below the line 3-1 of FIG. 3. In various embodiments, the sprocket 126 is concentrically fixed to the propeller shaft 119, which exits the lower unit bullet through the tail fairing 112. In various embodiments, the inside of the lower unit 114 is protected from sea water through seals on all edges and interfaces, including a set of shaft seals. In various embodiments, both leading edges 117 of the struts 116 contain coolant passages 117a to allow coolant to flow therethrough. In various embodiments, coolant can enter each strut through a coolant port, then flow through the coolant passages 117a, which removes heat from the coolant through conduction. Thus, the present disclosure provides a closed-circuit fluid cooling system, wherein the coolant circulation path is retained within the struts 116, nose cone 115 and anti-ventilation plate 120. Thus the coolant system does not need to rely on the intake of ambient water when in operation. In various embodiments, the coolant passage(s) 117a of each strut allows coolant to flow into a nose cone void 115a, which acts as a submerged, heat rejecting reservoir. In various embodiments, the nose cone void 115a contains one or more nose cone turbulators 115b (e.g. undulating structure/wall/strip) configured to increase turbulence of the heat transfer fluid and thus increase heat rejection capacity. Optionally, coolant passages 117a can extend throughout the anti-ventilation plate 120.

In various embodiments, coolant can flow bi-directionally through the struts 116 and to the thermal circuit 140 via the coolant passage 117a. In various embodiments, the coolant passage 117a may comprise tubing, hosing, pipes, and/or other methods of fluid transfer. In various embodiments, the thermal circuit may include an electronic controller pump and/or heat producing components including but not limited to the power electronics and prime mover. In various embodiments, a set of coolant port seals ensures the heat transfer fluid does not become contaminated. In various embodiments, additional voids may be provided in the trailing edge(s) 118, belt accommodation void 131, tail fairing 112, and/or lower unit 114 that can be used for additional coolant passages. In various embodiments, the longitudinal width of the belt accommodation void 131 can be varied for belts of different sizes. In various embodiments, the trailing edge 118 may be mechanically fastened by a set of trailing edge fasteners 118a configured to anchor into an anchor panel 118b (e.g., a T-block). In various embodiments, this method of attachment allows the trailing edges 118 to be separated from the struts 116 for installation and removal of the belt 130. In various embodiments, the belt accommodation void 131 may be optimized such that the size (e.g., width of the void space) of the void is minimized. In various embodiments, less void space may be better from a hydrodynamic standpoint (e.g., less drag area). In various embodiments, the belt accommodation void 131 may be about ⅛ inch on either side of the belt 130. In various embodiments, the sprocket gap 125 may have a similar ⅛″ gap. In various embodiments, the sprocket gap 125 may be smaller than the space between the belt 130 and an interior side of the belt accommodation void 131 as the belt may not have as much motion around the sprocket 126. In various embodiments, the belt accommodation void 131 may include a spacing (e.g., width) of about 0.01 inch to about 0.25 inch on either side of the belt. For example, 0.25 inch on either side of the belt 130 would result in 0.25 in+0.25 in+belt thickness (in inches) for the total width of the belt accommodation void 131. In various embodiments, the belt accommodation void 131 may include a spacing (e.g., width) of about 0.01 inch to about 6 inches on either side of the belt. In various embodiments, the spacing may scale with system size. In various embodiments, the spacing (e.g., width) may be about 12 inches on either side of the belt.

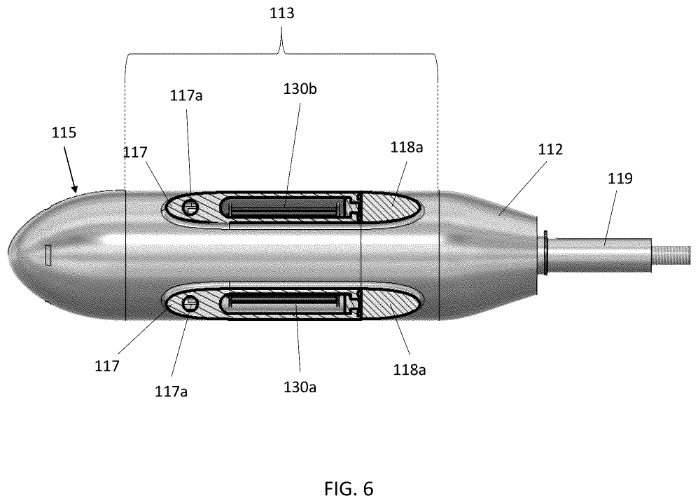

FIG. 6 illustrates a partial top view, partially in section, taken generally below the line 3-1 of FIG. 3. In various embodiments, the nose cone 115 has an outer contour that maintains an attached flow (e.g., reduces/prevents boundary layer separation) with the surrounding fluid body. In various embodiments, the nose cone 115 has a conical shape. In various embodiments, the nose cone 115 may be blunt or rounded at the tip. In various embodiments, the contour can be changed to suit different operating conditions. In various embodiments, the lower unit 114 may be cylindrical in shape and connected to both struts. In various embodiments, the trailing edges 118 may be connected to the struts 116 through fasteners anchored into the T-block 118b. In turn, the T-block is held by the walls of the dual strut bodies. In various embodiments, the leading edges 117 may include a coolant passage 117a having a circular diameter. In various embodiments, the coolant passage 117a may have a substantially constant diameter throughout the thermal circuit 140.

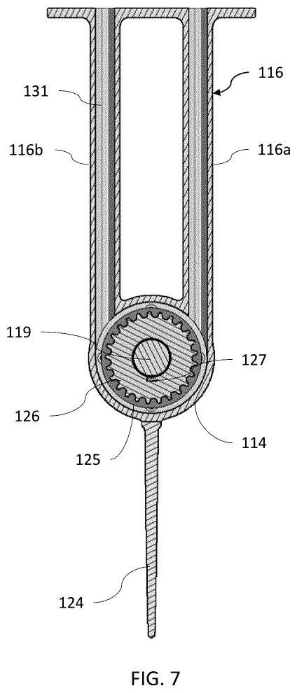

FIG. 7 illustrates a partial frontal view, partially in section, taken generally below the line 3-1 of FIG. 3. As shown in FIG. 7, the lower unit 114 and struts 116 include a belt accommodation void through which the belt 130 may pass. In various embodiments, the struts 116 include a strut inside wall and strut outside wall. In various embodiments, the strut inside wall and strut outside wall may be made of any suitable material, and can, but are not required, to be integrally formed with the rest of the strut body. In various embodiments, the thickness of the strut walls may be selected based on the application, either to increase robustness or decrease drag. In various embodiments, within the lower unit 114, the belt-driven sprocket 126 is concentric with the propeller shaft 119. In various embodiments, a keyway 127 is used to transmit torque between the sprocket 126 and propeller shaft 119. In various embodiments, a spline could be used or the sprocket 126 and propeller shaft 119 can be integrally formed. In various embodiments, to accommodate the thickness of the belt 130, an air-filled sprocket gap 125 exists in the lower unit 114. In various embodiments, due to the dual strut configuration, the belt 130 is able to rotate about the sprocket 126 without physically contacting any other part of the lower unit 114. In various embodiments, this contact-free operation allows for lubrication-free operation, compared to other motors which requires the belt or transmission components to operate in an oil-filled bath. The belt 130 can wrap around the sprocket 126, with engagement between respective surfaces over approximately 180 degrees of rotation of the sprocket. The sprocket 126 can include raised teeth, as shown, to increase the frictional engagement with the belt and generate greater torque.

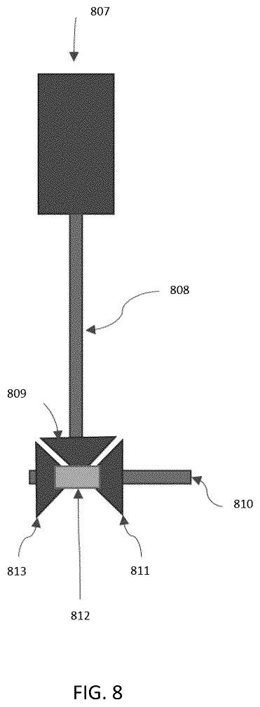

FIG. 8 illustrates a schematic representation of a traditional outboard power transmission system. In various embodiments, this utilizes a prime mover 807 with a vertically extending drive shaft 808. In various embodiments, power is transmitted from the vertical drive shaft and the horizontal prop shaft using gears. In various embodiments, a pinion gear is used 809 in conjunction with a crown gear 811 and 813 to transfer rotational velocity to the driven shaft. In many embodiments, a clutch is used with a sliding collar 812 that can engage either the clockwise or counter clockwise crown gear. In various embodiments, this mechanism enables a change in the rotation direction of the propeller shaft while maintaining drive direction of the prime mover.

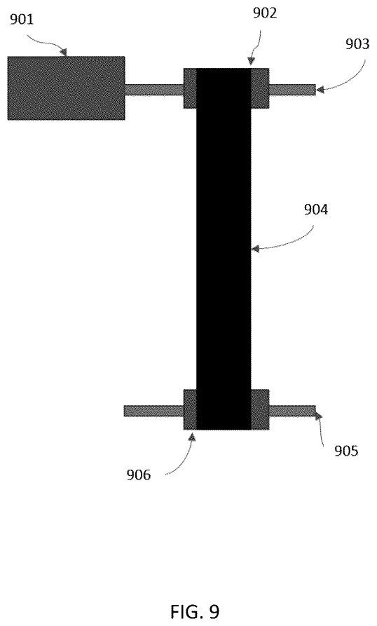

FIG. 9 illustrates a schematic representation of a belt drive transmission system. In various embodiments, this is a schematic representation of a certain embodiment for an alternative means of power transmission between a prime mover 901 and the lower driven shaft 905. In various embodiments, the prime mover utilizes a drive shaft extending horizontally 903, supporting a sprocket or gear 902, capable of driving a belt to the lower sprocket or gear 906 via a continuous loop 904.

In various embodiments, any struts may include non-linear shapes. In various embodiments, to accommodate a non-linear shape, the belt may remain substantially straight, but and the width of the belt accommodation void 131 (space between the belt and inside walls of the strut voids) may vary. In various embodiments, the struts may include pulleys (e.g., roller pulleys) configured to create a curve for the belt 130 to follow. In various embodiments, low friction pads can be positioned at any suitable position within the belt accommodation void 131. In various embodiments, any combination of the above three methods could work together to achieve a non-linear strut shape. In various embodiments, the leading edge of the struts may include a non-uniform profile (viewing from the top-down).

The various components disclosed herein (e.g., struts, nose cone, fairing, skeg) can be formed from a variety of materials including metals (e.g., aluminum, steel, titanium, etc.) rigid polymers and plastics, wood, etc. In various embodiments, the various components may include composite materials (e.g., carbon fiber, fiberglass, etc.). In various embodiments, the various components may include rubber. In various embodiments, the various components may include thermoplastics. In various embodiments, the various components may include any suitable metal-based alloys. In various embodiments, the various components may include materials with high thermal conductivity and high corrosion resistance. In various embodiments, the various components may include one or more coatings (anodize, powder coat, chemical vapor deposition, paint, etc.). In various embodiments, the various components may be formed from more than one material (i.e., nose cone could be mostly aluminum with a rubber based tip).

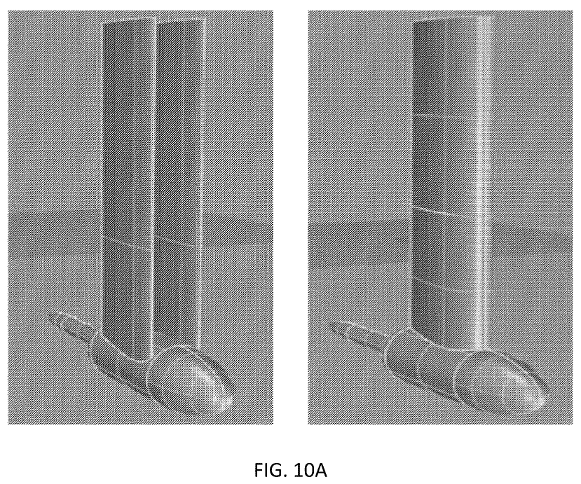

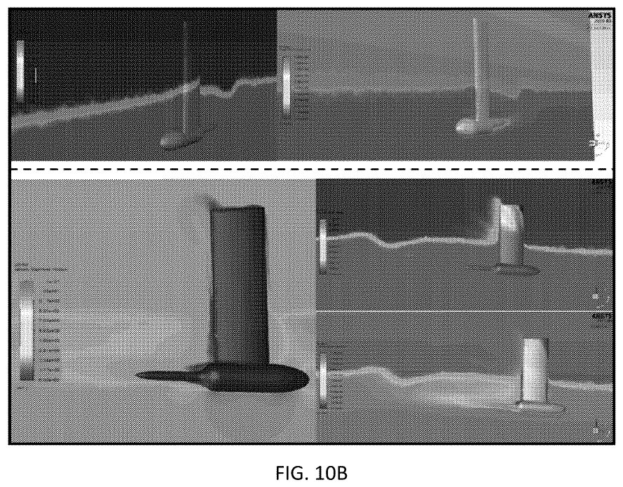

FIGS. 10A-10B illustrate a computational fluid dynamics visualization of the disclosed dual strut and a traditional single strut. In various embodiments, this half-body analysis was used to understand preliminary hydrodynamic effects and implications of a dual strut compared to a single strut. The plot of FIGS. 10A-10B shows a laminar flow as evidenced by the largely uniform shading of the fluid flowrate values (the darker portion of the plot in FIG. 10B is above the water line).

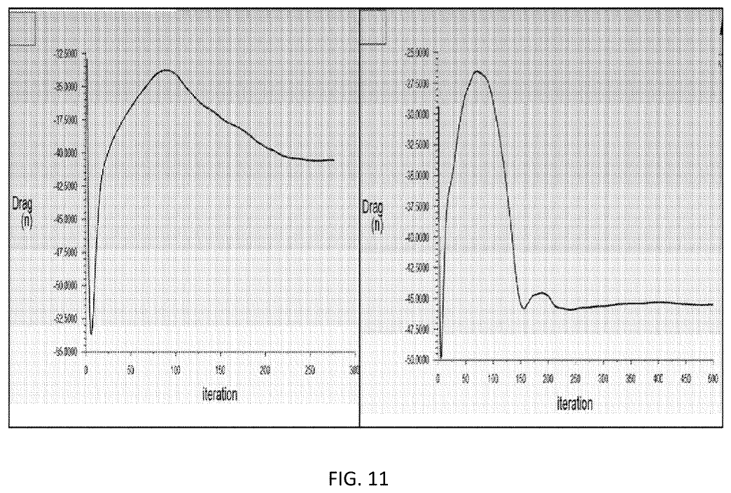

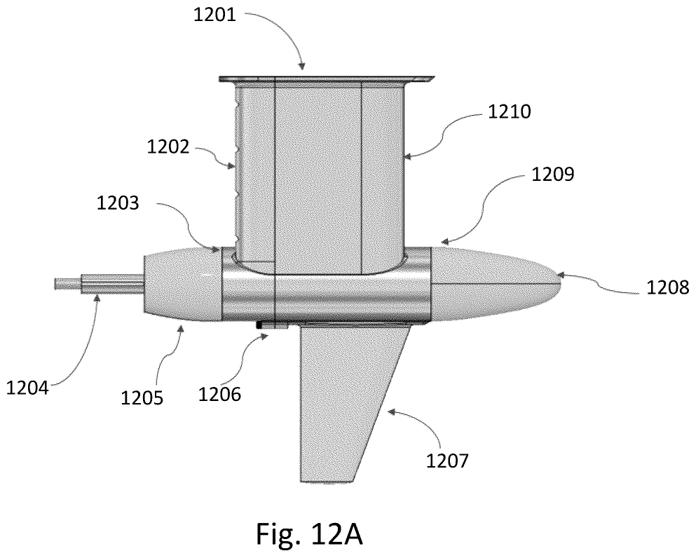

FIG. 11 illustrates a graphical representation of initial computational fluid dynamics drag results of the disclosed dual strut (left) (approximately 37,500 Newtons at iteration 150) compared to a traditional single strut (right) (approximately 45,500 Newtons at iteration 150). This simulation evidences the hydrodynamic advantages of a dual strut compared to a single strut.

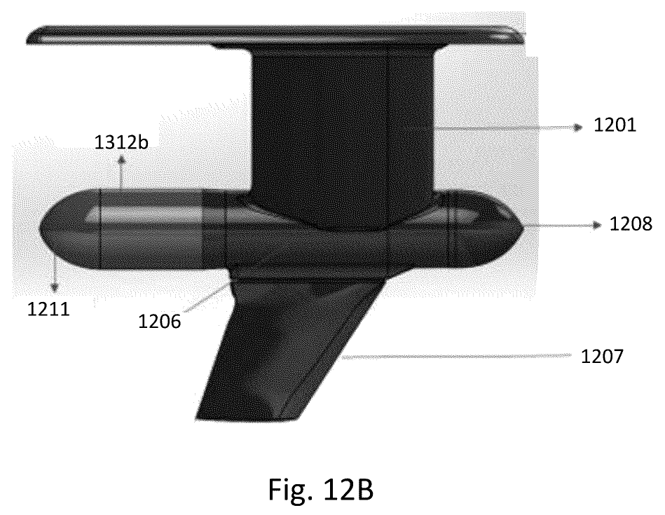

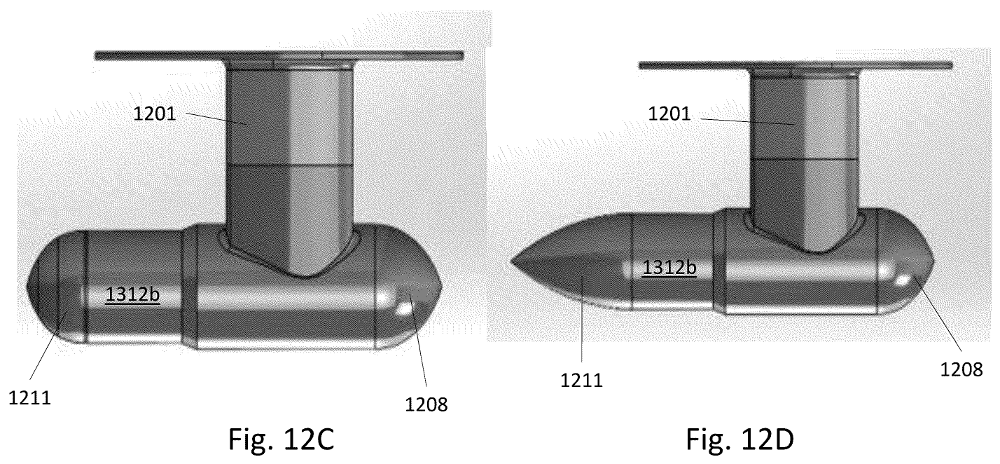

FIG. 12A-D illustrate a varying side profile views of an exemplary modular nose cone, tail cone, and skeg connected to a center body. In particular, FIG. 12 illustrates the submerged portion of a marine propulsion system that is connected via one or more struts 1201 to the rest of the propulsion system, such as a motor. In various embodiments, each strut 1201 may include a curved trailing edge 1202 with a radius. In various embodiments, the radius may be selected to optimize flow characteristics. In various embodiments the curved trailing edge may be elliptical, parabolic, a constant radius along the length of the strut, or a varying radius along the length of the strut. In various embodiments, each strut 1201 connects to the lower unit 1203. In various embodiments, the lower unit 1203 includes a nose cone 1208. In various embodiments, the lower unit 1203 includes a tail cone 1205. The lower unit 1203, nose cone 1208, and tail cone may be collectively referred to as a torpedo 1209. The lower unit 1203 includes center body 1206, center body 1206 may be the same or similar to center body 113.

In various embodiments, the tail cone 1205 is connected to the lower unit 1203 via fasteners (e.g., screws, clips, nut and bolt, latch, etc.) or using other non-permanent attachment methods. In various embodiments, the tail cone 1205 follows a continuous contour to the lower unit 1203. In various embodiments, the tail cone 1205 tapers from a larger diameter (e.g., diameter of the lower unit 1203) to a smaller diameter (e.g., the diameter of the propeller hub). In various embodiments, aft of the tail cone 1203, the propeller shaft 1204 extends outwardly from the lower unit and tail cone 1205 to support a propeller 1312. In various embodiments, the tail cone

In various embodiments, the skeg 1207 extends at least as deep as the propeller to thereby reduce the risk of submerged objects striking the propeller during operation. In various embodiments, the skeg 1207 is connected to the torpedo using mechanical fasteners that can be removed to replace the skeg to suit the size of the particular propeller (e.g., the longest radial length of the propeller).

In various embodiments, the nose cone 1208 acts as the leading edge of the lower unit 1203. In various embodiments, the nose cone 1208 may be shaped to optimize fluid flow around the lower unit 1203 and to the propeller 1312. In various embodiments, an outer contour of the nose cone 1208 includes a curve of constant or varying radius.

In various embodiments, the nose cone 1208 may be formed with a void space to house a fluid volume capable of dissipating thermal energy into the surrounding body of water. In various embodiments, the fluid may be a working fluid (e.g., a fluid having properties suitable to absorb energy and transfer the energy somewhere else). In various embodiments, the nose cone 8 connects to the lower unit 1203 with a continuous contour using either mechanical fasteners or other non-permanent bonding component. The leading edge 1210 of the vertical struts follows a curved profile. In some embodiments the curve is consistent along the length of the strut.

FIG. 12B illustrates another side profile view illustrating another optimized nose cone 1208 and tail cone 1205. The torpedo (or lower unit 1203) may further include a variety of propellers and/or propeller hubs, shown here as reference character 1312b). FIG. 12B further illustrates a tail cone 1211, which may be the same or similar to 111, the propeller cone may be fixed to the propeller shaft aft of the propeller 1312. Any of the torpedoes shown in FIG. 12A-D include a center body, the center body 113. FIG. 12B Shows one embodiment that has a slight positive taper to match the trailing edge of the tail cone to the diameter of the hub. This helps to reduce any additional incurred drag as it ensures a smooth continuous flow over the body. FIG. 12D shows another tail cone embodiment with a negative taper to mate the main body to the hub of the propeller.

FIG. 12C-D shows two embodiments of a modular prop cones with a common mating interfaces that have been optimized for different operating conditions. At slow speeds, friction drag is responsible for a higher proportion of drag, than at high speed. Therefore, it is important to reduce to the total wetted surface area, the driving force for friction drag. This can be seen in FIG. 12C (which has a smaller surface area than the embodiment of FIG. 12D). In some embodiments the nose cone 1208 can abut against the proximal edge of the main body portion (which receives the struts 1201); in some embodiments the nose cone can extend to overlap (or underlie) a portion of the main body portion. Additionally or alternatively, the profile of the assembly (nose cone+main body+tail cone) can be non-linear, and include stepped transitions in diameter. By comparison, at high speed, pressure drag becomes the dominating drag force. To maintain an attached flow at high speeds, minimizing pressure drag, the trailing edge taper should be more gradual, despite the increase in total wetted surface area. FIG. 12A-D shows the modularity of both the nose cones and the tail cones. Note that in various embodiments, the torpedo or lower unit also includes a tail faring, in which the width of the center body 1206 necks down as it approaches the propeller 1312 attachment point at the propeller hub 1312b. The shape of the modular nose cone 1208, center body 1206, tail faring 1205, propeller 1312, and tail cone (or propeller cone) 12 may all be modular such as to optimize the flow of water around the lower unit, depending on the mission set and environment. In accordance with an aspect of the disclosure, a first tail (and/or nose) cone (e.g. the bulbous embodiment shown in FIG. 12C) can be coupled to the main body of the motor and deployed for a first boating condition (e.g. relatively low speed environment/application), and removed/replaced with a second tail (and/or nose) cone having a different profile for a second boating condition (e.g. relatively high speed environment/application). This interchangeability of the motor fairings (leading and trailing edges) allows the same motor body portions (e.g. struts, belts, propeller blades, etc.) remain fixedly attached to the motor/boat while proving the (fluid dynamic) flexibility to adapt or switch to different operating conditions while ensuring maximum performance (minimized drag).

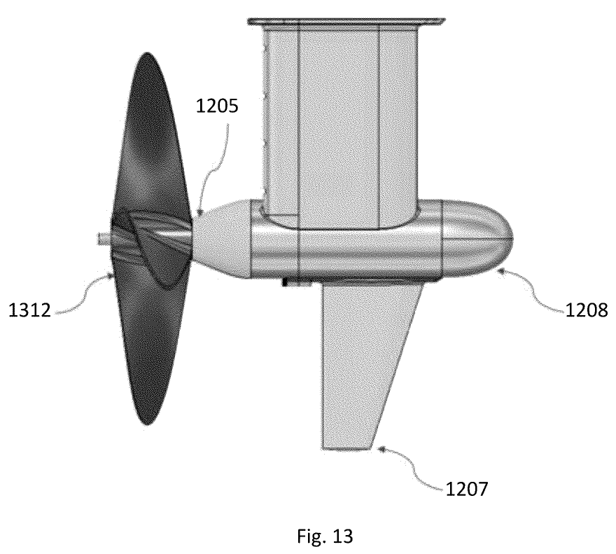

FIG. 13 illustrates a side profile view of an exemplary modular nose cone, tail cone, and skeg connected to a center body.

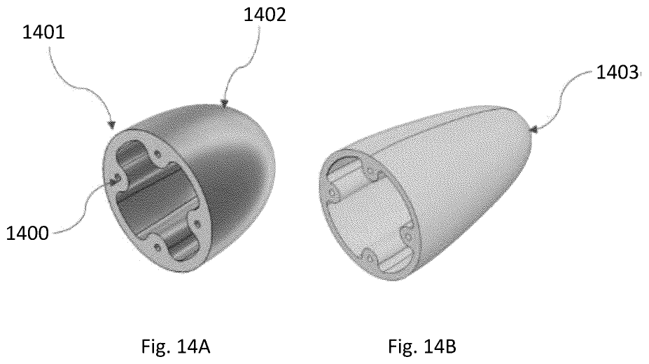

FIGS. 14A-14B illustrates two exemplary nose cones optimized for different uses. In particular, FIGS. 14A-14B depict a side-by-side comparison of two embodiments for the nose cone. In both FIGS. 14A-14B, the nose cone 1208 has an outer diameter 1401 that matches the leading edge of the lower unit 1203. In various embodiments, the profile of the leading edge 1402 may follow a parabolic curve to minimize the total drag of the submerged lower unit. In various embodiments, the nose cone 1208 is affixed to the lower unit 1203 using one or more fasteners 1400 that can be removed or installed as needed (e.g., to swap the nose cone 1208 out with another nose cone). The fasteners 1400 can be retained within an inwardly protruding channel (e.g. disposed along the interior wall of the nose cone). This interior channel can also serve as a reinforcement structure (or “rib”) and extend towards the nose cone. As shown in FIG. 14A, the profile of the leading edge 1402 may include a larger radius and a smaller or non-existent taper from trailing edge to leading edge. In other embodiments, as shown in FIG. 14B, the profile of the leading edge 1402 includes a smaller radius at the leading edge and a taper along the length from the trailing edge (larger cross-sectional diameter) to the leading edge (smaller cross-sectional diameter). In various embodiments, as shown in FIG. 14B, the overall length of the nose cone may be extended to thereby increase the volume of the void space compared to other embodiments, such as the nose cone of FIG. 14A. In various embodiments, a larger volume of void space may allow for more components to be contained within the nose cone 1208.

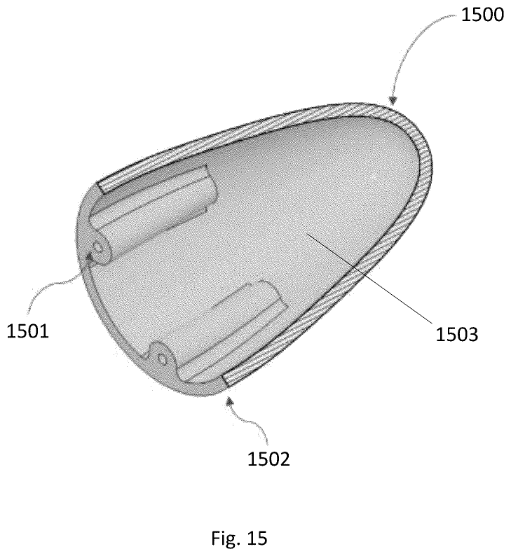

FIG. 15 illustrates a cross-sectional view of a nose cone with internal reservoir for heat dissipation. In various embodiments, the nose cone comprises an outer shell having a thickness 1500 to thereby accommodate a cavity 1503 inside. In various embodiments, the thickness changes along the length of the nose cone (e.g. thicker at the apex, or leading edge, than at the trailing edge; or vice versa). In various embodiments, the nose cone is connected to the lower unit using one or more fasteners 1501, enabling the nose cone to be interchanged. In various embodiments, a widest outer diameter of the nose cone 1502 matches the leading edge diameter of the lower unit 1203 such that the transition from the lower unit 1203 to the nose cone is smooth with the vertical edge of the nose cone abutting a vertical edge of the main body 1203.

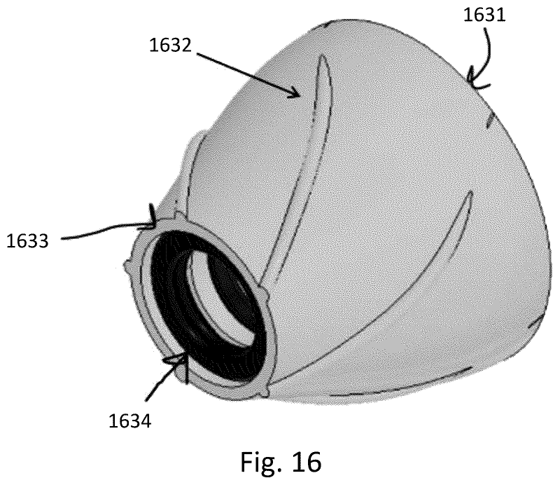

FIG. 16 illustrates a modular tail cone with integrated pre-swirl vanes 1632 that project outwardly (a uniform distance, or in a tapered fashion) from the surface of the tail cone. In various embodiments, hydrodynamic appendages may be provided on the tail cone to thereby condition the fluid flow to rotate in the opposite direction to that of the propeller. In various embodiments, hydrodynamic appendages may improve the angle of attack of the flow when the fluid reaches the propeller 1633, thereby increasing the propulsive efficiency of the propeller. In various embodiments, a pre-swirl tail cone works to minimize the angular momentum of the flow, increasing the propulsive efficiency. In various embodiments, a rotary shaft seal 1634 may be housed within the tail cone. In various embodiments, the seal is a dry running seal that allows the shaft to rotate with minimal drag but eliminate intrusion of any water. In various embodiments, the tail cone has an outer diameter 1631 substantially equal to that of the lower unit 1203. In various embodiments, a widest outer diameter 1631 of the tail cone matches the trailing edge diameter of the lower unit 1203 such that the transition from the lower unit 1203 to the tail cone is smooth.

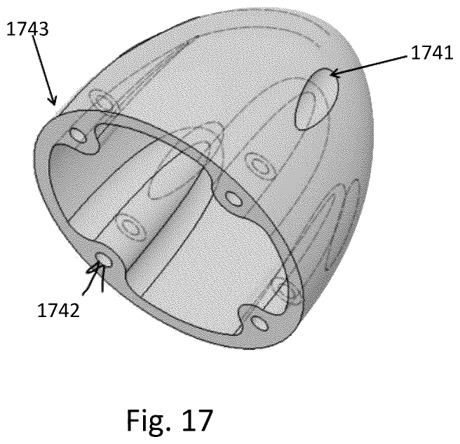

FIG. 17 illustrates an exemplary nose cone with external access mounting hardware for rapid replacement. In various embodiments, the nose cone includes forward accessible mounting pattern 1741. For example, recesses 1741 can be formed in the nose cone which receive fasteners (and associated tooling, e.g. screw driver shaft). These recesses 1741 can be aligned with the internal channels 1742, as described above. In various embodiments, a trailing edge of the nose cone has the same outer diameter 1743 as the lower unit 1203 to allow it to be interchanged with other nose cones. In various embodiments, the nose cone includes a pattern of counter sunk holes 1742 configured to allow bolts to be oriented with the head of the bolt inside the nose cone.

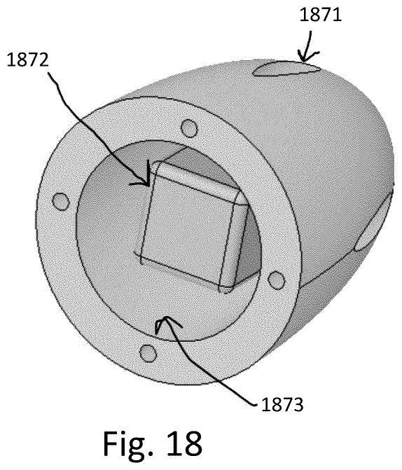

FIG. 18 illustrates a nose cone with an integrated fluid sensor to measure water quality used in oceanographic research. In particular, the nose cone includes forward accessible mounting bolt pattern 1871 and an integrated sensor housing 1872. In various embodiments, the void space within the nose cone 1873 can be used as a reservoir of coolant or to house an array of sensors for oceanographic research.

When moving through a fluid, drag is the resistive force that a body experiences. Drag typically has two causes: Friction forces, a shear stress acting parallel to the boundary layer between the body and fluid and Pressure forces, a stress acting normal (perpendicular) to the boundary layer. The coefficient of drag C_{d} is the sum of the total pressure (C_{P}) and friction (C_{f}) across the entire surface area of the submerged body. This is calculated using the Drag Equation below:

$$\begin{matrix}{c}_{d} = \frac{2 {F}_{d}}{ρ {v}^{2} A} \\ = {c}_{p} + {c}_{f} \\ = {\underbrace{\frac{2}{ρ {v}^{2} A} {\int }_{S} dS ( p - {p}_{o} ) ( \hat{n} \cdot \hat{i} )}}_{{c}_{p}} + {\underbrace{\frac{2}{ρ {v}^{2} A} {\int }_{S} dS ( \hat{t} \cdot \hat{i} ) {T}_{w}}}_{{c}_{f}}\end{matrix} . \qquad EQ 1$$

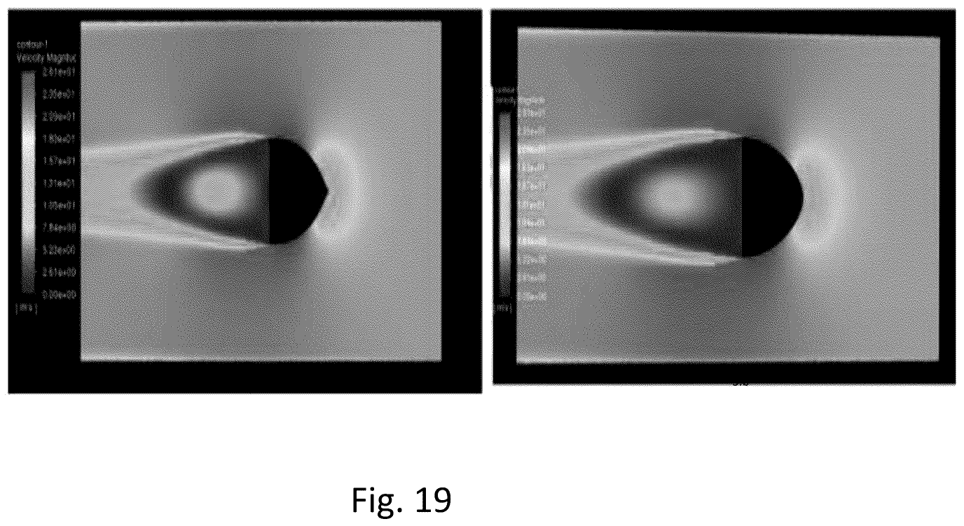

Referring now to FIG. 19, two nose cones that share a common mounting interface and have been optimized for different operating conditions. The velocity contour map shown is representative of the pressure drag generated by the body moving through a flow of water. Optimized for different conditions, the appropriate component can be selected based on application and operating conditions. Pressure drag results from the force required to compress the fluid particles on the leading face of the submerged body and separating the fluid particles on the trailing face. FIG. 19A shows a more dramatic decrease in flow velocity on both the leading and trailing faces, resulting in higher pressure drag. This shows that for the given velocity condition, the nose cone in FIG. 19B is optimal.

The design of the tail cone is key to maintaining an attached, laminar flow that the propeller can use to generate forward thrust. As with the nose cone, different operating conditions will have different optimal propeller designs. Depending on the intended application, an optimal propeller may vary in blade shape/number or use a different hub diameter. Using a modular tail cone, it is now possible to select a tail cone profile that is optimized for a specific propeller.

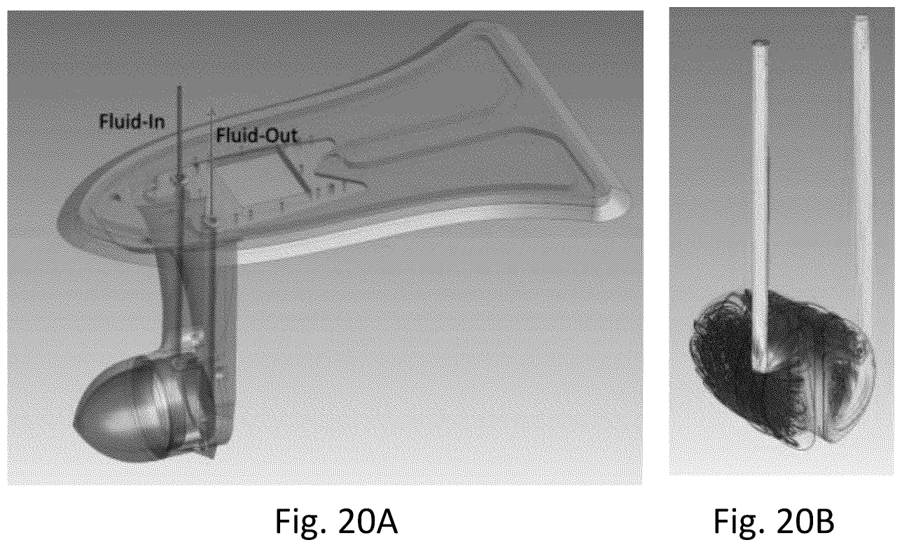

Referring now to FIG. 20A-B, a depiction of an embodiment including a modular nose cone with a hollow internal cavity, as part of an internal closed loop cooling system. A closed loop cooling system does not ingest external fluid, such as salt water, to cool internal sensitive components, limiting the effect corrosion. One of the core challenges associated with using a closed loop cooling system is dissipating sufficient waste heat to maintain safe temperatures for the heat generating components. To optimize thermal dissipation out of the system, both the internal and external geometries can be varied depending on the flow conditions. The optimal design for the internal cavity cooling minimizes the pressure drop through the cavity, maximizes heat transfer out the system and minimizes the drag of the body through the flow.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A marine propulsion apparatus, the apparatus comprising:
a lower unit, the lower unit comprising:
a center body, the center body comprising a leading edge disposed at a first end of the center body and a trailing edge disposed at a second end of the center body, defining a substantially cylindrical portion therebetween;
a modular nose cone member releaseably coupled to the leading edge of the center body, the modular nose cone further comprising a first curved conical surface and a first mating surface;
a modular tail cone member releaseably coupled to the center body, the modular tail cone further comprising a second conical surface and a second mating surface, the second mating surface oriented towards and parallel to the first mating surface; and
a skeg affixed to a bottom side of the center body.

2. The apparatus of claim 1, wherein the lower unit comprises a propeller shaft disposed axially with the center body.

3. The apparatus of claim 1, wherein the lower unit comprises a propeller affixed to the propeller shaft aft of the center body.

4. The apparatus of claim 3, wherein the lower unit comprises a tail faring affixed to the propeller shaft aft of the center body.

5. The apparatus of claim 1, wherein the modular tail cone comprises integrated pre-swirl vanes disposed on an outer conical surface.

6. The apparatus of claim 5, wherein the modular tail cone comprises a rotary shaft seal disposed at an aft portion of the modular tail cone, the rotary shaft seal configured to allow the modular tail cone to rotate and prevent an ingress of water.

7. The apparatus of claim 1, wherein the modular nose cone is affixed to the center body via at least one fastener.

8. The apparatus of claim 1, wherein the modular tail cone is affixed to the center body via at least one fastener.

9. The apparatus of claim 1, wherein the modular nose cone comprises a void space.

10. The apparatus of claim 9, wherein the void space comprises a fluid.

11. The apparatus of claim 10, wherein the fluid is air.

12. The apparatus of claim 1, wherein the modular nose cone comprises a curved conical surface having a constant radius.

13. The apparatus of claim 1, wherein the modular tail cone comprises a curved conical surface having a constant radius.

14. The apparatus of claim 1, wherein the modular nose cone comprises a fluid sensor.

15. The apparatus of claim 14, wherein the fluid sensor is configured to measure a water quality datum.

16. The apparatus of claim 14, wherein the fluid sensor is disposed within an integrated sensor housing within the modular nose cone.

17. The apparatus of claim 16, wherein the integrated sensor housing is surrounded by a coolant disposed within the modular nose cone.

18. A marine propulsion apparatus, the apparatus comprising:
torpedo, the torpedo comprising:
a center body, the center body comprising a leading edge disposed at a first end of the center body and a trailing edge disposed at a second end of the center body, defining a substantially cylindrical portion therebetween;
a modular nose cone member releaseably coupled via at least one fastener to the leading edge, the modular nose cone further comprising a first curved conical surface and a first mating surface, the first mating surface having a first diameter substantially the same as the leading edge;
a modular tail cone member releaseably coupled via at least one fastener to the trailing edge, the modular tail cone further comprising a second conical surface and a second mating surface, the second mating surface oriented towards and parallel to the first mating surface and wherein the second mating surface comprises a second diameter substantially the same as the trailing edge;
a propeller shaft disposed axially within the center body, terminating at the modular nose cone at a first end, and extending through the trailing edge at a second end;
a propeller rotatably fixed to the propeller shaft aft of the modular tail cone, the propeller comprises a plurality of blades;
a propeller cone rotatably fixed to the propeller shaft aft of the propeller;
a skeg affixed to a bottom side of the cylindrical portion of the center body.

19. The apparatus of claim 18, wherein the modular tail cone comprises integrated pre-swirl vanes disposed on an outer conical surface.

20. The apparatus of claim 18, wherein the propeller shaft is rotatably coupled to a motor, the motor configured to rotate the propeller shaft, and in turn, rotate the propeller.
